(19) United States
(12) Patent Application Publication
(10) Pub. No.: US 2014/0063790 A1
(43) Pub. Date: Mar. 6, 2014

(54) LED Based Lighting Systems for Use on Wearable Articles

(71) Applicant: Philip Gold, Austin, TX (US)

(72) Inventor: Philip Gold, Austin, TX (US)

(21) Appl. No.: 13/844,902

(22) Filed: Mar. 16, 2013

Related U.S. Application Data
(60) Provisional application No. 61/696,867, filed on Sep. 5, 2012.

(51) Int. Cl. A42B 3/04; F21V 21/08

(52) U.S. Cl. CPC A42B 3/044; F21L 15/14
USPC 362/106; 362/103

(57) ABSTRACT

The present invention is directed to an LED lighting system adapted for use on the surface of wearable articles, such as headwear (e.g., helmets), outwear (coats, jackets), and sporting wear (uniforms). The LED lighting system may be used to provide safety lighting, for example, ambient illumination of the wearer's movements.

### FIELD OF THE INVENTION

The present invention relates to LED (light emitting diode) based systems which are secured to a wearable article, such as, headwear, clothing articles and carrying packs to provide a desired illumination, and to wearable articles comprising such LED systems.

### BACKGROUND OF THE INVENTION

U.S. Pat. No. 5,570,946 relates to lighting for protective headwear in which the lighting arrangement is preferably installed at least partially inside the outer layer of the protective headwear.

U.S. 20040228127 relates to cluster of LEDs formed by housing of discrete LEDs within a single lens housing and coupling the LEDs together. The LEDs may be used as lighting for a safety helmet in which the LED is coupled in or to the external surface of the helmet so as to cause the helmet to emit light in a desired pattern and color.

U.S. 20070063831 is directed to a signal system for a motorcycle or bicycle in which and LED based indication mechanism is attached to a garment of the rider.

U.S. 20090213586 is directed to an LED sticker which includes a body made out of a flexible plastic material having multiple light transmitting portions, a plurality of LEDs embedded in the light transmitting portions, a control circuit assembly mounted on a sticker body and electrically connected with the LEDs for controlling operation of the light emitting diodes, a battery cell for providing the light emitting diodes with the necessary working voltage, and a flexible magnetic pad or double-sided adhesive member at the bottom side of the sticker body for securing the sticker body to a vehicle by means of magnetic attraction or adhesion.

There is a need in the art for a cost effective system to provide improved safety lighting to a user which is easily applied to a wearable article.

### SUMMARY OF THE INVENTION

The present invention is directed to light emitting diode (LED) systems adapted for use on the surface of wearable articles, such as, headwear (e.g., helmets), outwear (coats, jackets), and sporting wear (uniforms), belts and carrying packs. The LED systems of the present invention may be used to provide a desired illumination, such as, safety lighting in the form of increased ambient illumination to distinguish the wearer within poorly lit surroundings, and to improve the wearer's mobility in those surroundings. The LED systems of the present invention comprise at least one flexible LED lighting strip which is able to conform to the shape of the surface of a wearable article, said flexible strip comprising
(i) an upper surface having one or more LEDs disposed thereon which are operably positioned to provide a desired illumination;
(ii) a lower surface which mates with a surface of the wearable article;
(iii) an attachment for securing the flexible strip to the surface of the wearable article; and
(iv) an electrical connector for electrically connecting the LED strip to a power source.

In particular aspects of the present invention, the flexible strip (flexible LED unit) contains front emitting LEDs, side emitting LEDs and/or organic light-emitting diodes (OLEDs).

The power source for supplying power to the one or more LEDs is electrically connected to the one or more LEDs via the electrical connector of the flexible strip, and in a particular aspect of the present invention, the power source for the LED system is electrically connected to the flexible strip by a power cord. Accordingly, an advantage of this aspect of present invention is that the LED system of the present invention permits the power source to be located in a separate location from the wearable article.

By using a cable to position the battery or other power source away from the LED strip (attached to the wearable article), the weight of the lighting system is distributed to reduce wearer fatigue.

In an alternative aspect of the present invention, the power source for the LED system is attached to or forms a part of the flexible strip, and is applied to the wearable article. In this aspect, the power source should preferably be light weight.

The LED system may contain a predetermined and/or prearranged number of LEDs. Alternatively, the LED system may be adjustable to permit the addition and/or subtraction of LEDs from the flexible strip, as desired for the applicable wearable article. The LEDs may be used to illuminate a single color or multiple colors, as desired, and may be flashing or non-flashing, as desired, as well as combinations thereof.

The invention also relates to wearable articles comprising the LED systems of the present invention, including helmets, hats, caps, coats, jackets, belts and carrying packs.

The invention further relates to kits for applying an LED system to a wearable article, the kit comprising at least one flexible strip of the present invention comprising a predetermined number of LEDs operationally positioned thereon, an attachment for connecting the flexible strip to a wearable article, a power cord for connecting the flexible strip to a power source, and optionally a power source.

### BRIEF DESCRIPTION OF DRAWINGS

FIG. 1 shows an embodiment of the LED light system configured for a motorcycle helmet.

FIG. 2 shows the left profile of an embodiment of an LED system on a motorcycle helmet.

FIG. 3 shows an embodiment of an LED system for a motorcycle helmet with LED strip power cord and connector fastened against the helmet when not attached to the power source.

FIG. 4 shows a detail of the hook and loop fastening system embodiment that secures the LED strip power cord and connector against a motorcycle helmet when not attached to the power source.

FIG. 5 shows an embodiment of a motorcycle helmet LED strip attached to a battery power supply with power cable.

FIG. 6 shows embodiments of the LED light system configured for a motorcycle helmet, hard hat, and bicycle helmet.

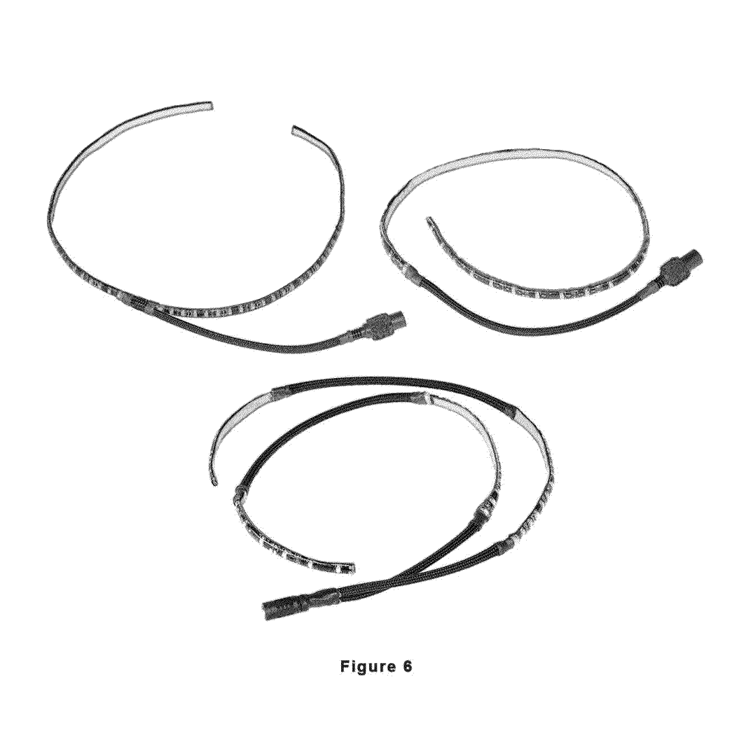

FIG. 7 shows embodiments of an LED system on a hard hat, motorcycle helmet attached to a battery power supply with power cable, and bicycle helmet.

FIG. 8 shows a hard hat with an embodiment of a hook and loop fastening system that secures the LED strip power cord and connector against a motorcycle helmet when not attached to the power source.

FIG. 9. shows a detail of another embodiment of a hook and loop fastening system embodiment on a hard hat.

### DETAILED DESCRIPTION OF THE INVENTION

The present invention is directed to LED systems and wearable articles comprising the LED systems.

Strip and Strip Construction

The strip used in the LED lighting system of the present invention has an upper surface (in which the LEDs are mounted on, preformed therein or connect to form the strip (upper surface and lower surface), and a lower surface which mates with the wearable article. The lower surface of the strip may further contain the attachment mechanism for securing the strip to the wearable article, such as, e.g., Velcro (including in the form of a-hook and loop structure), high bond tape, snaps or magnet.

In an embodiment, the LED strip is composed of housings for the LEDs, in which multiple LED housings connect to form the strip. In this embodiment, the upper surface of the housing displays the LED, and a lower surface of the strip mates with the wearable article, either directly or via an attachment. The LED strip is operably connected to incorporate or to connect to a power source (e.g., battery) for powering the LEDs.

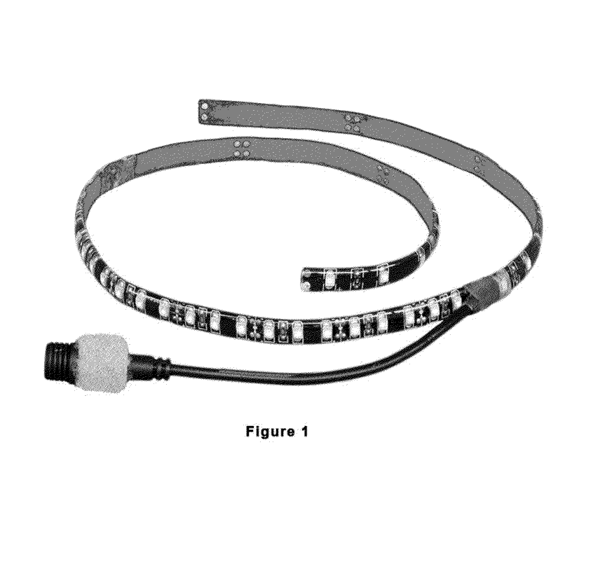

An embodiment of the strip is shown in FIG. 1, in which the strip (of a predetermined length adapted for use to a wearable article) includes an upper surface comprising the LEDs (operationally positioned), and lower (flat) surface for attachment (mating) to a surface of a wearable article.

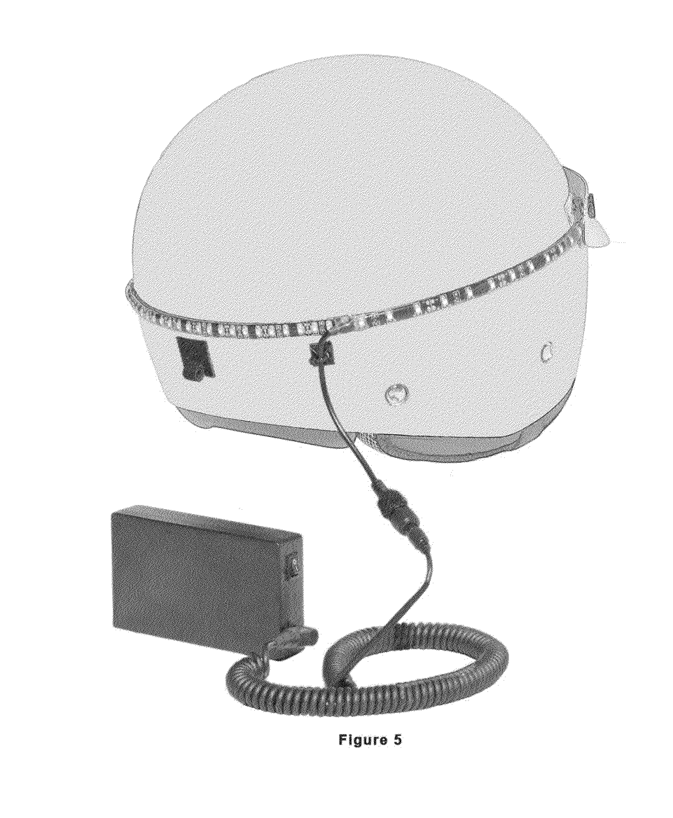

The strip may further include an electrical connector for electrically connecting the LED strip to a power source, as further shown in FIGS. 1 and 5. The LED strip may be connected to a power source via a power cable, as shown in FIGS. 1 and 5. In an alternative embodiment, the power source is connected directly to or forms part of the strip and is applied on the wearable article. The LED strip preferably withstands multiple mating cycles so that strip lights, power cables, and battery can be connected or separated as needed.

The LED strip is composed of any flexible material, such as a flexible printed circuitry material which may be conformed to the shape of the wearable article. Examples of flexible materials used for the LED strip include polymer/plastic substrates, such as, e.g., polyamide, polyether ether ketone (PEEK) and transparent conductive polyester film.

The strip can use color changing LEDs or a mix of LEDs with each emitting a single color or plurality of colors. The LEDs are positioned on the strip to provide the desired lighting pattern.

The length of the strip should conform to the desired length for application to the wearable article. For example, for a helmet, it may be desired, for example, to have lighting which provides lighting from 20 to 220 degrees around the helmet.

In particular embodiments, the LED lighting system comprises more than one LED lighting strip, such as two, three, four or more LED lighting strips. The strips are preferably operably connected and powered by the same source and arranged to provide the desired lighting pattern.

Any suitable LED may be used. Examples of LEDs suitable for use in the present invention include front emitting LEDS, side emitting LEDs and/or organic light-emitting diodes (OLEDs). Examples of front emitting LEDs include, SMD3528, SMD3014, SMD5050, and SMD5630, which are commercially available. Examples of side emitting LEDs include SMD335 which is commercially available.

Attachment

Any suitable attachment may be used to connect the LED lighting system to the surface of the wearable article. In a particular aspect of the present invention, the attachment used to secure the LED lighting system to the surface of the wearable article may be a removable adhesive material or non removable adhesive material transposed onto one or more parts of the lower surface of the flexible strip. The removable adhesive material may include, for example, a Velcro material (which mates with Velcro material transposed on to a surface of the wearable article), tape, film, or any other removable adhesive known in the art. The non-removable adhesive material may include a chemical adhesive material in which the adhesive property of the chemical adhesive is inhibited (e.g., by a covering) until the LED lighting system is ready to be secured to the wearable article, and examples include, VHB foam tape or double sided adhesive transfer tape.

In yet another embodiment, the removable material may be one or more magnets, e.g., disposed on the lower surface, which mate with a magnetic surface on the wearable article. The magnets are either of a small enough size and/or are positioned on the lower surface of the flexible strip to not interfere with the flexibility of the strip for application to the wearable article. In an alternative embodiment, the magnets are flexible.

The attachment mates directly with the surface of the wearable article or alternatively mates with a material applied to the wearable article (e.g., for a Velcro attachment, a corresponding Velcro material applied to the wearable article). In a particular embodiment, the attachment is a hook and loop attachment or other male-female attachment.

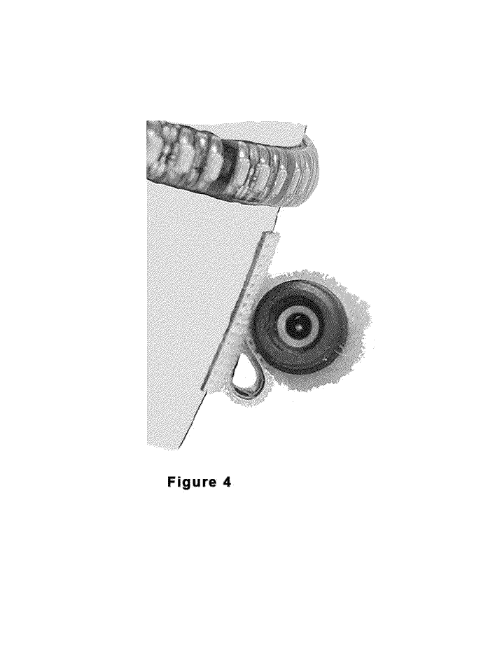

The electrical connector may also be preferably secured to the wearable article using an attachment, including any of the above attachments. In another particular embodiment, the power cord is secured to the surface of a wearable article using an adhesive material. The connection to the power source (or to cord to the power source) may further be secured using the combination of an adhesive (e.g., Velcro) shaped into a loop structure as exemplified in FIG. 4, which provides increased surface area to strengthen the attachment.

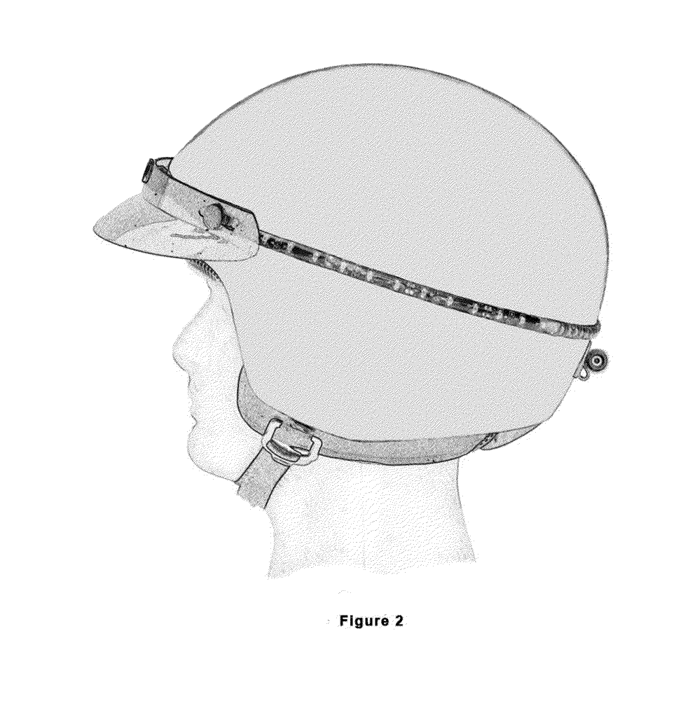

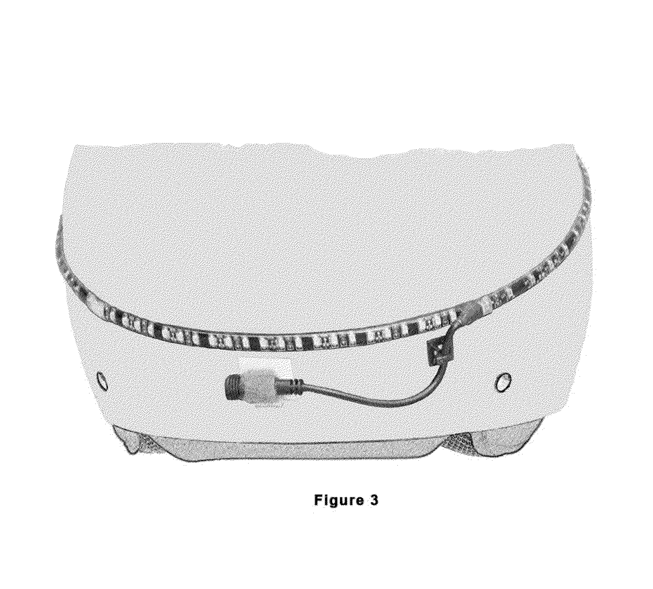

An embodiment of the present invention as attached to a wearable article is shown in FIG. 2 for a motorcycle helmet, in which the lower surface of the LED strip (not shown) mates with the wearable article, and the upper surface of the strip containing the LEDs is exposed to transmit light. The power source may be connected in the rear of the helmet, and the distal end of an embodiment of the electrical connector for electrically connecting the LED strip to a power source is shown in FIG. 2, which may further be secured using hook and loop mechanism and Velcro (as partially shown). A rear view of this embodiment is shown in FIG. 3, including the electrical connector secured to the wearable article using two attachment points, including a hook and loop embodiment for the electrical connector.

A more detailed view of a hook and loop attachment embodiment for securing the electrical connector to the wearable article is shown in FIG. 4 in which the surface area for attachment is increased by the formation of loop at one end of a Velcro attachment disposed on the wearable article. The electrical connector contains Velcro disposed around the circumference of the electrical connector which mates with the Velcro of the loop. Although not shown, further stabilization of attachment may include a second loop, located at the opposite (shown as upper) end of the Velcro attachment, for mating with the Velcro disposed around the circumference of the electrical connector.

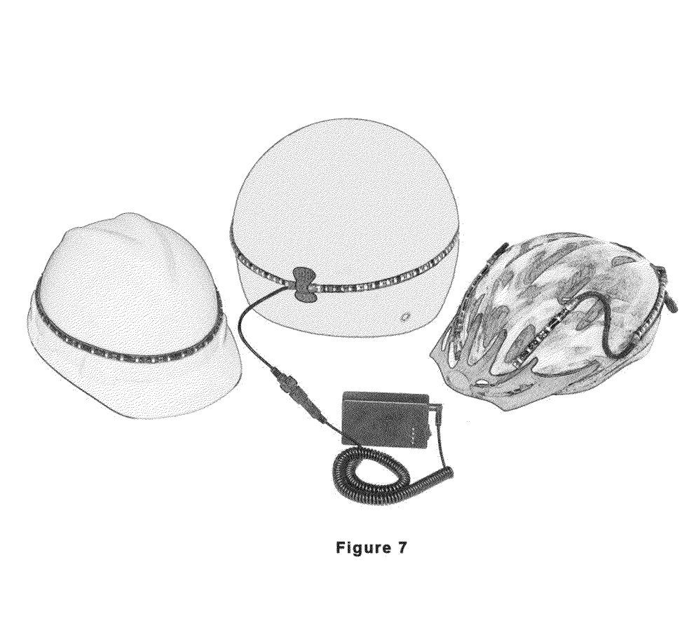

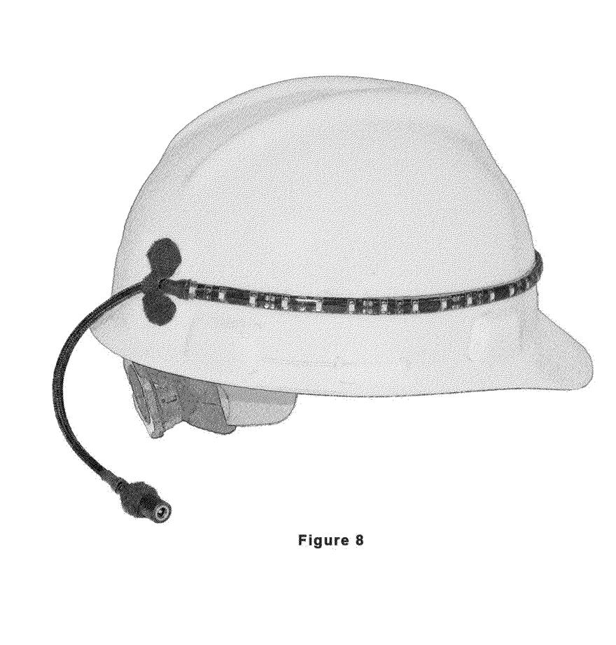

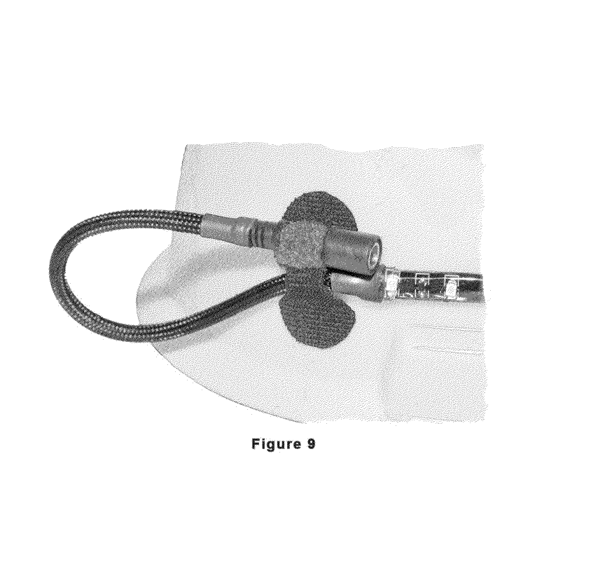

In another embodiment, the velcro may be disposed on top of the LED strip as shown, e.g., in FIGS. 7-9, and connector attached to the Velcro.

Power Source

Any suitable power source may be used. The power source may be provided from an external power source, e.g., the LED safety light system may be connected to a portable battery by a power cable or to the power source of a device, for example, a machine a user is operating which supplies power. By using a cable to position the battery or other power source away from the LED strip, weight of the lighting system is distributed to reduce neck and back wearer fatigue. An embodiment of this aspect of the invention is shown in FIG. 5, in which the power source is connected to the LED strip attached to a wearable article (shown as a motorcycle helmet). In this embodiment, the power source may be held at a desired location and away from the wearable article.

In an alternative embodiment, the power source is a component of the LED safety light system (e.g., a battery operably connected to the power strip and applied to the wearable article), and is accordingly also secured to the wearable article using any suitable attachment. In such embodiment, the power source is preferably light weight.

Examples of batteries include a rechargeable 3800 mAh Li-ion battery, which has approximately 10 hours of continuous operating time. Battery examples also include rechargeable batteries (electrical and/or solar powered) and small power source cell batteries. In another embodiment, the present invention may be powered by more than one power source selected from DC power sources including batteries, fuel cells, photovoltaic cells, and AC to DC power generators, or combinations thereof.

In a particular aspect, the present invention provides a safety lighting system adapted for a helmet (e.g., motorcycle, bicycle or construction helmet). In this embodiment, the safety lighting system provides a 120 degree beam angle when attached to the helmet.

The LED lighting system may be activated by a control device comprising an on and off switch for controlling the power supply, and optionally, LED lighting settings if LED lighting options are permitted, such as, e.g., selecting the lighting color or pattern emitted by the LED (e.g., selecting a lighting setting from a plurality of lighting options).

Wearable Articles

The LED lighting system of the present invention is adapted for use on the surface of a number of wearable articles, such as, headwear (e.g., construction helmets, mining helmets, motorcycle helmets, biking helmets, baseball caps, cloth caps, hoods), outwear (coats, jackets, vests), footwear (boots, shoes), and sporting wear (uniforms, belts).

It will be understood that the specification is illustrative of the present embodiments and that other embodiments within the spirit and scope of the claimed embodiments will suggest themselves to those skilled in the art. Although this invention has been described in connection with specific forms and embodiments thereof, it would be appreciated that various modifications other than those discussed above may be resorted to without departing from the spirit or scope of the invention as defined in the appended claims.

1. An LED system for attachment to a wearable article, comprising at least one flexible strip which is able to conform to the shape of the surface of a wearable article, said flexible strip comprising (i) an upper surface having one or more LEDs disposed thereon which are operably positioned to provide a desired illumination; (ii) a lower surface which mates with a surface of the wearable article; (iii) an attachment for securing the flexible strip to the surface of the wearable article, and (iv) an electrical connector for connecting to a power source.

2. The LED system of claim 1, further comprising a power source electrically connected to the electrical connector of the LED system for supplying power to LED system.

3. The LED system of claim 1, wherein the power source for the LED system is electrically connected to the electrical connector by a power cord.

4. The LED system of claim 3, wherein the power source for the LED system is not attached to the wearable article.

5. The LED system of claim 1, wherein the power source for the LED system is attached to or forms a part of the flexible strip, is attached to the wearable article.

6. The LED system of claim 1, wherein the one or more LEDs are placed directly on the upper surface of the flexible strip.

7. The LED system of claim 1, wherein the LED flexible strip has a predetermined number of LED mating sites having light transmitting portions corresponding to the positions of the one or more LEDs.

8. The LED system of claim 1, wherein the flexible strip is a front emitting flexible LED strip, side emitting flexible LED strip and/or organic light-emitting diode strip.

9. The LED system of claim 1, wherein the LED system contains a predetermined and/or prearranged number of LEDs.

10. The LED system of claim 1, wherein the LED system is adjustable to permit the addition and/or subtraction of LEDs from the flexible strip.

11. The LED system of claim 1, wherein the attachment is an adhesive material transposed onto one or more parts of the lower surface of the flexible strip.

12. The LED system of claim 11, wherein the adhesive material is a Velcro material.

13. The LED system of clam 11, wherein the adhesive material is a chemical adhesive material.

14. The LED system of claim 13, wherein the attachment is double sided adhesive transfer tape.

15. The LED system of claim 1, wherein the attachment is by one or more magnets.

16. The LED system of claim 1, wherein the attachment is a hook and loop attachment or other male-female attachment.

17. A wearable article comprising the LED system of claim 1.

18. The wearable article of claim 17, wherein the wearable article is selected from the group consisting of a helmet, hat, cap, shirt, coat, jacket, vest, belt or carrying pack.

19. The wearable article of claim 17, wherein the wearable article is a construction helmet, a motorcycle helmet or bicycle helmet.

20. A kit for applying an LED system to a wearable article, said kit comprising a flexible strip comprising a predetermined number of LEDs operationally positioned thereon, an attachment for connecting the flexible strep to a wearable article, a power cord for connecting the flexible strip to a power source.
